(19) United States
(12) Patent Application Publication
(10) Pub. No.: US 2010/0259023 A1
(43) Pub. Date: Oct. 14, 2010

(54) STEERABLE WHEEL SAFETY SYSTEM

(76) Inventors: David Cebon, Cambridge (GB); Brian Jujnovich, Cambridge (GB); Alan Geoffrey Dixon, Clwyd (GB)

Correspondence Address: WELSH & FLAXMAN LLC, 2000 DUKE STREET, SUITE 100, ALEXANDRIA, VA, 22314, US

(21) Appl. No.: 12/444,180

(22) PCT Filed: Oct. 2, 2007
(86) PCT No.: PCT/GB2007/003731

§ 371 Date: May 6, 2010

(30) Foreign Application Priority Data
Oct. 3, 2006 (GB) 0619529.1

(51) Int. Cl. B62D 13/00; G06F 19/00; B62D 5/06

(52) U.S. Cl. 280/89; 701/41

(57) ABSTRACT

A safety system for at least one steerable wheel of a vehicle. The system comprises an actuating means and a locking means and is arranged such that, upon a predetermined condition arising, the actuating means effects centring of the or each wheel and the locking means then effects locking of the or each centred wheel.

The present invention relates to a steerable wheel safety system and, more particularly, to a system which centres and locks steerable trailing wheels of a vehicle.

The invention has been devised in particular, though by no means solely, for steerable trailing wheels of an articulated vehicle such as a tractor semi-trailer.

The invention has particular application to the wheels of a semi-trailer (i.e. the trailer unit of a tractor semi-trailer) but also has application to the trailing wheels of a tractor unit of a tractor semi-trailer, or indeed the trailing wheels of a rigid truck or articulated lorry.

The wheels in a trailer unit of a semi-trailer are often fixed parallel to the longitudinal axis of that trailer, significantly limiting the maneuverability of the semi-trailer and giving rise to transverse drag as a result of the wheels not aligning with the direction of travel during turning. This causes the tyres of the trailer unit wheels to scrub, giving rise to premature wear, road damage and increased fuel consumption.

In order to address these problems, arrangements have been developed to render the trailer unit wheels steerable. Whilst such arrangements greatly improve maneuverability, they introduce risks associated with control of the trailer unit, particularly where its wheels are steered, in the event of an emergency or fault in the steering system, such as a power loss, sensor failure, hydraulic failure or controller error.

There is thus a need for an arrangement which can reliably restore a degree of control to the vehicle, in the event of a fault or emergency, of a vehicle having steerable trailing wheels.

Accordingly the invention resides in a safety system for at least one steerable wheel of a vehicle, the system comprising an actuating means and a locking means and being arranged such that, upon a predetermined condition arising, the actuating means effects centring of the or each wheel and the locking means then effects locking of the or each centred wheel.

The predetermined condition may be constituted by a fault, the fault comprising loss of power to the system, a loss of fluid pressure in the system, a sensor or other electrical failure and/or a controller error, or the predetermined condition is constituted by a controller-detected emergency situation, e.g. a burst tyre or failure of another component, or a dangerous condition such as imminent rollover.

In the case where the or each wheel is that of trailer unit of an articulated vehicle, such as a semi-trailer, the system is thus able to fix the wheel(s) parallel to the longitudinal axis of the trailer unit, i.e. into straight-forward positions, thereby centring them, rendering the trailer unit as controllable as it would be if the or each wheel were permanently fixed. In the case where the or each wheel is that of tractor unit, the system is, similarly, able to fix the wheel(s) parallel to the longitudinal axis of the tractor unit, i.e. into straight-forward positions, thereby centring them.

Preferably, the locking means is arranged to be placed into a locking condition, to effect locking of the or each wheel, under the release of energy stored, e.g. pre-accumulated, in the system, for example under the action of a resilient bias, such as by way of a spring which may be contained in the locking means. The system may then be configured such that fluid pressure and/or power prevents activation of the locking means, whereby a loss of that pressure/power will allow the release of the energy, e.g. the resilient bias, to force the locking means into its locking condition. In this way, the locking means may be rendered fail-safe.

Preferably, the system is arranged to effect centring of the or each trailing wheel upon the predetermined condition arising, under the release of potential energy stored, e.g. pre-accumulated, therein. Preferably, the system is arranged to effect centring under the release of pressurised fluid (liquid or gas) in the system or may, alternatively, be arranged to effect centring under spring or mechanical energy. In this way, if a fluid supply to the system fails, the system is still able to power the centring of the or each wheel and, in this sense, is fail-safe. Preferably, the system is configured such that electrical power prevents the release of the stored energy (such as by way of a valve operated by a solenoid which must be energised to keep the valve closed, thus preventing release of pressurised fluid), whereby a loss of that power will result in release of the stored energy to centre the wheel(s), thus conferring a further fail-safe aspect.

Preferably, the system comprises a body which is arranged to be supported from the vehicle and the actuating means comprises an actuating member which is received by the body and displaceable with respect to the body to effect movement of a linkage to centre the or each wheel. In a preferred embodiment of the invention, the linkage is a steering linkage (i.e. a linkage used for normal wheel steering during driving) which moves to steer, and thereby to centralise, the wheel(s).

It is to be understood that the term “linkage” as used herein is intended to be broad in scope and to refer to any arrangement via which the wheels are centred.

According to a preferred feature of the invention, the body is arranged to be supported from an axle beam of the vehicle. In a preferred embodiment of the invention, the actuating member, in situ, forms part of the linkage and is displaceable linearly with respect to the body such that the linkage is moved to steer the or each wheel to its straight-forward position. In an alternative preferred embodiment of the invention, the actuating member is displaceable rotationally with respect to the body and is arranged to engage the linkage to centralise the wheel(s) such that the linkage is moved to steer the or each wheel to its straight-forward position, the actuating member, which may comprise an output shaft of a rotary actuator (which may be hydraulic, pneumatic or electric and may define the body), preferably being positionable such that an axis of rotation of the actuating member is parallel or collinear with a steering axis of a wheel to be centred, for instance being adapted to be mounted on a steering kingpin.

Preferably, the body is arranged to be mounted to, or at least fixed with respect to, the axle beam so that the or each wheel may be centred and locked into its straight-forward position according to a given displacement of the actuating member, irrespective of effects created by suspension interposed between the axle and the vehicle chassis.

Alternatively, the body may be arranged to be supported from a body of the vehicle. With the body so supported, it may be located a considerable distance from the road and thus less vulnerable to debris from the road, as well as being able to enjoy the vibration-absorbing characteristics of the vehicle suspension, whereby the life of the system may be prolonged.

In a preferred embodiment, the or each wheel comprises a pair of wheels pivotally supported from opposite ends of the axle beam by pivotable members which form part of the linkage. In an alternative preferred embodiment, the system is arranged to effect centring, as well as normal steering, of only one wheel of the pair of wheels whilst another such system is mounted to the axle beam to centre the other wheel, thereby allowing independent steering/centring of the wheels to achieve perfect Ackermann geometry at all times.

According to particular embodiments of the invention, the system is arranged to effect centring and locking of at least one further wheel pivotally supported from an end of at least one further axle beam of the vehicle by a pivotable member, via a linkage interposed between the system and the or each further wheel. According to one embodiment of the invention, the body and the locking means are arranged to be supported from different ones of the axles, with the linkage possibly being supported from a different axle still, thus exploiting the plural axle beams to distribute the components of the system.

Preferably, the actuating member is arranged to steer the wheel(s) via a fixed geometry linkage.

Preferably, locking means comprises a locking member which is moveable between a first position, in which it allows movement of the steering linkage and a second position, in which engages the steering linkage to prevent movement of the steering linkage. Preferably, the locking member is arranged to be urged towards its second position under the action of a resilient bias. Preferably, the locking member is movable in a direction transverse to that in which the steering linkage is displaceable and is arranged, when urged towards its second position, to abut the steering linkage slidably whilst the or each wheel is not in its straight-forward position and to be moved, into a space defined by the steering linkage, to its second position to engage the actuating member upon the or each wheel being steered into its straight-forward position. In one embodiment, the locking member comprises a hydraulically-released, spring activated shot-bolt and the space comprises a hole in the actuating member which receives the shot-bolt when brought into alignment therewith, upon the or each wheel being steered to its straight-forward position. Accordingly, locking can be reliably effected without a need to time the operation of the locking member according to the position of the wheel(s).

According to an alternative preferred feature of the invention, the system is arranged to effect centring and locking of a wheel which is supported from a single end of the axle beam.

In particular embodiments of the invention, the system is arranged to effect steering and locking of at least one further trailing wheel pivotally supported from an end of at least one further axle beam of the vehicle.

Preferably, the system comprises a double-acting cylinder and a piston received in the cylinder, and the actuating member comprises at least one rod extending from the piston, the or each rod being to impart steering torque to a respective wheel.

Preferably, the system member comprises a first elongate portion, received in the body, and a second elongate portion which is aligned with but offset from the first elongate portion and is fixed with respect to the first elongate portion, the second elongate portion being slidably received by the body to prevent rotation of the body with respect to the actuating member. In particular embodiments, the second elongate portion may thus prevent rotation or pitching of the body about the first elongate portion, so as to stabilise the system with respect to the vehicle. In those embodiments in which the system comprises a cylinder, the first elongate portion comprises the or each rod of the piston and said space is preferably provided in the second elongate portion.

Preferably, the system comprises a double-acting cylinder and a piston received in the cylinder to define therein a first chamber to one side of the piston and a second chamber to the other side of the piston, the actuating member comprises a rod of the piston, and the system further comprises a fluid inlet, to receive fluid from a fluid source, a first line, in fluid communication with the inlet and arranged to supply fluid to the first or second chamber to effect steering of the or each wheel when the predetermined condition has not arisen, and a second line, arranged to supply fluid to the first or second chamber to effect steering of the or each wheel to its straight-forward position upon the predetermined condition arising.

Preferably, the system comprises an accumulator, arranged to supply fluid to the second line, and the second line comprises a valve which is openable to allow fluid to flow from the accumulator through the second line upon the predetermined condition arising. Preferably, the valve in the second line comprises a solenoid arranged to be de-energised upon the predetermined condition arising to open the valve, whereby the aforementioned fail-safe characteristic may be realised. Alternatively, the valve in the second line may be mechanically activated.

Preferably, the system comprises a control valve, interposed between the second line and the cylinder, the control valve comprising a first outlet, arranged to supply fluid to the first chamber, and a second outlet, arranged to supply fluid to the second chamber, the control valve being arranged to output fluid, according to the position of the or each wheel, through one of the first and second outlets, to effect steering of the or each wheel to its straight-forward position when the predetermined condition has arisen. In a preferred embodiment of the invention, the system further comprises a cam arrangement, mechanically linking the piston rod and the control valve, which is movable by the piston rod to adjust the output from the control valve according to the position of the piston rod with respect to a predetermined position, i.e. the direction in which the piston rod is displaced from the predetermined position and possibly also the amount by which it is so displaced, the predetermined position being that assumed by the piston rod when the or each wheel is straight. Accordingly, operation of the control valve need not rely on external power, fluid pressure or the like, and may thus also be rendered fail-safe.

In a preferred embodiment of the invention, the control valve comprises a proportional control valve. In an alternative preferred embodiment of the invention, the control valve comprises a servo valve.

Preferably, the system comprises a further control valve, interposed between the first line and the cylinder, the further control valve comprising a first outlet, arranged to supply fluid to the first chamber, and a second outlet, arranged to supply fluid to the second chamber, the further control valve being arranged to output fluid, through its first and second outlets, to effect steering of the or each wheel according to a signal generated by a computer controller based on various measured signals when the predetermined condition has not arisen. Such signals may include a signal corresponding to the position of a driver's hand wheel of the vehicle. Preferably, the further control valve comprises a first solenoid, arranged to control the output from the first outlet of the further control valve, and a second solenoid, arranged to control the output from the second outlet of the further control valve, the first and second solenoids being arranged to be de-energised upon the predetermined condition arising to close the first and second outlets of the further control valve. Accordingly, a loss of power to the first and second solenoids will close the further control valve to prevent steering according to said signals, thus conferring a further fail-safe characteristic upon the system.

In a preferred embodiment of the invention, the further control valve comprises a proportional control valve. In an alternative preferred embodiment of the invention, the further control valve comprises a servo valve.

More preferably, the system comprises first and second outlet lines connected to the first and second outlets, respectively, of the control valve, and first and second further outlet lines, connected to the first and second outlets, respectively, of the further control valve, the first outlet line and first further outlet line meet at a first junction and the second outlet line and second further outlet line meet at a second junction, and the first and second outlet lines are respectively provided, upstream of the junctions, with first and second one-way valves preventing fluid flow in the direction from the junctions towards the control valve. Preferably, the system further comprises a first load control valve, interposed between the first junction and the first chamber, and a second load control valve, interposed between the second junction and the second chamber, the load control valves, owing to their positions downstream of both control valves being able to influence the fluid flow to the cylinder under the operation of either control valve.

Preferably, the locking means is arranged to be placed into its locking condition under the action of a resilient bias therein and is arranged to receive fluid to prevent it from being placed into its locking condition under the action of that bias, the system comprises a third line arranged to supply fluid to the locking means, the third line having a valve which is arranged to be open, to allow fluid supply to the locking means when the predetermined condition has not arisen, and closed upon the predetermined condition arising, and the system further comprises a fluid discharge valve arranged to be closed, to prevent fluid from being discharged from the locking means when the predetermined condition has not arisen, and open, to allow fluid to be discharged from the locking means upon the predetermined condition arising. More preferably, the valve of the third line is provided with a solenoid, which is arranged to be de-energised upon the predetermined condition arising to close the valve of the third line, and the fluid discharge valve also comprises a solenoid which is arranged to be de-energised upon the predetermined condition arising to open the fluid discharge valve, whereby a loss of electrical power to the solenoids will give rise to the locking condition, thus rendering the valve of the third line and fluid discharge valve fail-safe.

Preferably, the third line is arranged to be supplied, at a position therealong which is upstream of the valve on the third line, with fluid from the accumulator, for supply to the locking means to prevent it from assuming its locking condition.

In a preferred embodiment of the invention, the valve on the third line is arranged to open (following wheel centring and locking), to allow fluid to be supplied to the locking means to take it out of its locking condition, only if fluid pressure in the accumulator, or, more generally, in the third line upstream of the valve, reaches a predetermined level. This may be achieved by an interlock, such as an electrical interlock interposed between the accumulator and the valve on the third line, the interlock being sensitive to the pressure in the accumulator to open the valve on the third line upon that pressure reaching the predetermined level. Accordingly, the system can be arranged such that, after it effects wheel centring and locking, it cannot be reset, to allow resumption of steering, until there is confirmed to be sufficient pre-accumulated fluid pressure to power a subsequent wheel centring and locking operation.

In an alternative preferred embodiment of the invention, the bias in the locking means is set high enough such that it will prevent the locking means from being taken out of its locking condition until the fluid pressure in the accumulator reaches the predetermined level, at which level the pressure of the fluid supplied to the locking means is sufficient to overcome the bias. In such an embodiment, the system can, similarly, be prevented from being reset until it is confirmed that the accumulator is able to power, on its own, a subsequent wheel centring and locking operation.

Preferably, the second line is arranged to be supplied, at a position therealong which is upstream of the valve on the second line, with fluid from the inlet, and a one-way valve is interposed between the inlet and said position, to prevent fluid from flowing from the second line towards the inlet. Accordingly, the wheel straightening can be effected by the supply of fluid from the fluid source, as an alternative or supplement to the supply of fluid from the accumulator.

Preferably, the third line is arranged to be supplied, at a position therealong which is upstream of the valve on the third line, also with fluid from the inlet, and a one-way valve, which may be that referred to in the preceding paragraph, is interposed between the inlet and said position, to prevent fluid from flowing from the third line towards the inlet. Accordingly, the wheel straightening can be effected by the supply of fluid from the fluid source, as an alternative or supplement to the supply of fluid from the accumulator. Advantageously, the accumulator may be arranged to be filled with fluid from the inlet via the one-way valve.

Preferably, the one-way valves are check valves and thus require no power supply to operate, thus conferring an additional fail-safe characteristic.

A preferred embodiment of the invention will now be described in detail with reference to the accompanying drawings in which:

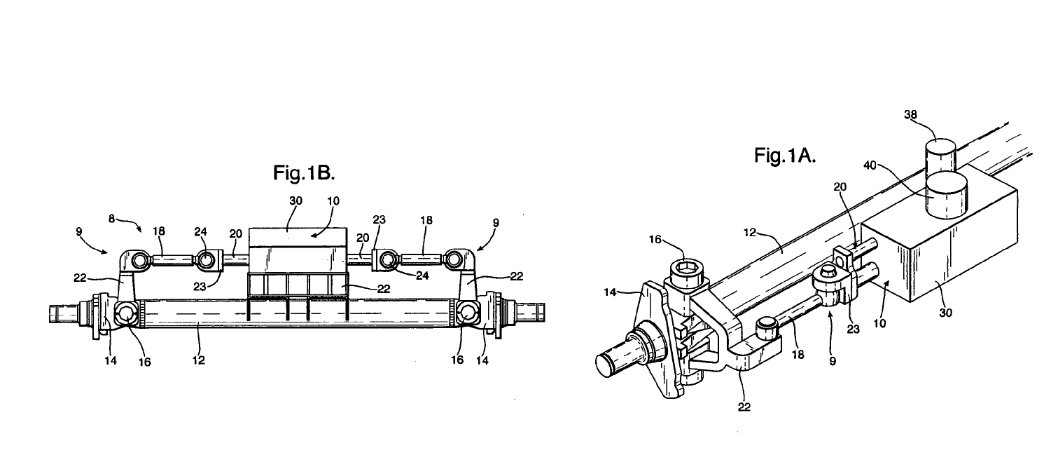

FIG. 1A is a perspective view of an axle assembly incorporating a system according to the preferred embodiment;

FIG. 1B is a schematic plan view of the axle assembly the system as illustrated in FIG. 1A;

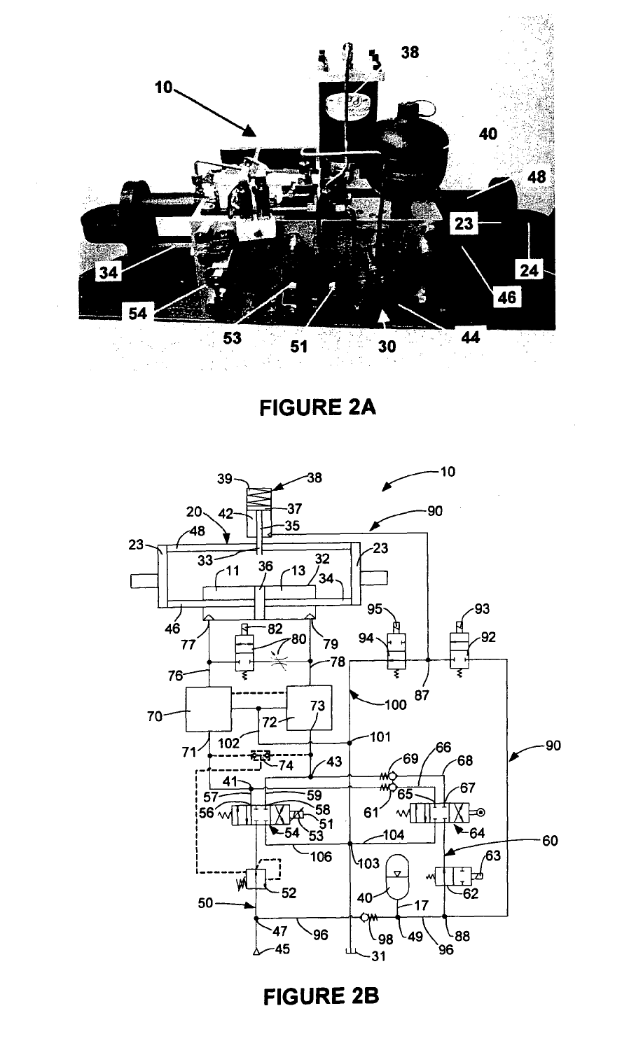

FIG. 2A is a front perspective view of the system according to the preferred embodiment; and

FIG. 2B is a hydraulic circuit diagram of the system shown in FIG. 2A.

The system is provided, according to the preferred embodiment, as a self-contained unit 10, as depicted in FIGS. 1A, 1B and 2A, and is for effecting steering and locking of a pair of trailing wheels of an articulated vehicle and, in particular, a pair of wheels (not shown) supported from a common axle beam 12 of a trailer unit of a semi-trailer.

The unit 10 and axle beam 12 form part of a steering axle sub-assembly 8, which further comprises a pair of steering swivel members 14, or pivotable members, a pair of kingpins 16, which pivotally support the steering swivel members 14 from opposite ends of the axle beam 12, and a pair of tie rods 18, pivotally connected at their inner ends to an actuating member 20 (which in this embodiment comprises the rods of a dual-rod, double-acting cylinder) of the unit 10, and pivotally connected at their outer ends to distal ends of steering arms 22 provided as part of the steering swivel members 14. The unit 10 sits on and is fixed to a bracket 22 provided on the axle beam 12 so as to be rigidly mounted to the front of the axle beam 12. The actuating member 20, tie rods 18 and swivel members 14, including arms 22, define a steering linkage 9.

The steering axle sub-assembly 8 may be one of a plurality of such assemblies on the vehicle. For example, in the case of a tandem axle or tri-axle trailer unit, two or three such sub-assemblies may be respectively employed, i.e. one per axle beam.

The steering swivel members 14 may receive wheel brakes (not shown).

As is clear from FIG. 1B, the steering linkage defined in sub-assembly 8 defines a fixed-geometry linkage.

The sub-assembly 8 associated with the preferred embodiment, as is clear from FIGS. 1A and 1B, is not only simple in its design but also arranged so that the wheels can be steered with very low actuation force in order that they can be restored to their straight-forward position (i.e. a position in which their axes of rotation are parallel with the longitudinal axis of axle beam 12) by a relatively low actuation force.

Moreover, by appropriate adjustment of the dimensions of the elements in the steering linkage, the embodiment provides steering geometry which closely approximates Ackermann geometry, despite control of the pair of wheels being interdependent.

Furthermore, the specific layout of the unit and links, which is sometimes known as a “rack and pinion” arrangement, provides particular advantages over the “four bar” linkages traditionally used on steering axles. In this regard, since the unit is mounted on the axle beam, steering is not effected by suspension movements, i.e. there is no “bump” or “roll” steer. In addition, Ackermann geometry, as referred to above, is better approximated.

The layout and operation of the unit 10 will now be described, with reference to FIGS. 2A and 2B.

The unit 10 comprises a body 30, having a generally rectangular cross-section, for housing or receiving the various unit parts, including the double-acting, dual-rod hydraulic cylinder 32, the rods 34 of which, as extending from piston 36, form a first elongate portion 46 of the actuating member 20. Advantageously, the unit 10 is compact and self-contained, with all mechanical and hydraulic components mounted on or in the body 30.

The unit 10 is arranged to operate, under appropriate hydraulic and electrical control, in an active steering mode, a self-steering mode and a locking mode. In the active steering mode, the forces are provided in accordance with signals from a control computer (not shown) installed on the trailer unit in response to sensor signals. Many sensor arrangements are possible, depending on the control strategy, which may involve, in a tractor and semi-trailer application, measuring the articulation angle between the tractor and/or a number of other parameters such as vehicle speed, lateral acceleration, vehicle yaw rate, wheel steering angles actuation pressure and side slip.

In the self-steering mode, the forces are provided by way of an exchange of fluid between chambers in the cylinder, defined to opposite sides of the piston, under the influence of forces exerted through the steering sub-assembly 8 to the piston 36 by the wheels.

In the locking mode, the unit 10 is arranged to steer the wheels back to the straight-ahead position and lock them in that position to prevent further steering movement. The unit 10 is configured to provide an indication to the vehicle driver that the emergency condition, giving rise to the emergency locking, has arisen. Moreover, the unit 10 is configured not to be resettable (i.e. for active steering or self-steering) until the emergency condition has been removed, such as by restoring the electrical or hydraulic integrity of the unit.

The unit 10 includes a spring-activated, hydraulically-released “shot-bolt” cylinder 38 (constituting a locking means), to lock the actuating member 20 and thus the wheels and a hydraulic accumulator 40, for centring the wheels, prior to locking, in the event of a fault or emergency, a proportional directional control valve 54, an arrangement of solenoids 51, 53, a manifold block 44, which receives the hydraulic fluid from a hydraulic power pack mounted on the vehicle, an inlet 45, to provide fluid from the manifold block 44, and actuating member 20, which comprises, in addition to the first elongate portion 46, a second elongate portion 48 extending parallel thereto. The first 46 and second 48 elongate portions are rigidly fixed at their opposites ends by connecting members 23,23, which are provided with eyes 24, for pivotal connection to tie rods 18. The elongate portions 46,48 and connecting members 23, which define the actuating member 20, form a rectangular frame which affords the actuating member 20 high stiffness. The second elongate portion 48 is slidably received in the body 30 to prevent the body 30 from pivoting (pitching) about the first elongate portion 46.

The manifold block 44 is arranged to receive, for supply to the inlet 45, hydraulic fluid from a DC electric power pack incorporating an accumulator and batteries which may be recharged by an alternator charging circuit (not shown), provided on the trailer unit, thus eliminating the need to run hydraulic pipes from the tractor unit to the trailer unit. Electrical power is provided to the unit 10 from the batteries. Alternatively, the power pack could be powered by pressured air from the a pneumatic system on the vehicle.

The hydraulic circuit diagram for the unit 10 is shown in FIG. 2B, from which it can be seen that the unit 10 further comprises a first supply line 50, along which hydraulic fluid from the inlet 45 is supplied to the cylinder 32 during active steering, and a second supply line 60, along which hydraulic fluid is supplied to the cylinder 32 from accumulator 40 in the locking mode.

Insider the cylinder 32 is a first chamber 11, defined to one side of the piston 36, and a second chamber 13, defined to the other side of the piston 36. The wall of the cylinder 32 is provided with a first port 77 and a second port 79 which provide fluid communication between the outside of the cylinder 32 and the first and second chambers 11,13 respectively.

The first supply line 50 supplies fluid to a proportional directional control valve 54 which has two outlets 56,58, from which run respective outlet lines 57,59 for directing hydraulic fluid to the chambers 11 and 13, respectively, via respective load control valves 70,72 which are described in further detail below. The proportional directional control valve 54 comprises two solenoids 51,53, which control the fluid flow rate, into the outlet lines 57,59, through outlets 56 and 58 respectively.

Disposed on the first supply line 50 is a pressure-reducing valve 52 which operates in conjunction with a pilot 74, interposed between inlets 71,73 to the load control valves 70,72, to sense pressure on either side of the proportional directional control valve 54 and maintain a constant pressure drop thereacross. Owing to the constant pressure drop across the proportional directional control valve 54, as effected by the pressure reducing valves 52, the flow rate through outlet 56 and outlet 58 is dependent purely on the current in solenoid 51 or solenoid 53, respectively, as output according to the steering mode (active or self-steer) employed.

The fluid from outlets 56, 58 passes through the respective load control valves 70,72, before entering the cylinder 32.

Each load control valve provides the following:
load holding, preventing movement of the piston 36 unless the control lines are pressurised;
counterbalancing, ensuring that the piston cannot overrun;
cross-port pressure relief, allowing fluid to escape from either side of the cylinder if pressure becomes excessive; and
anti-cavitation and purging, i.e. making up fluid to prevent cavitation and allowing any air in the cylinder to be quickly purged.

Interposed between outlets 76,78 of the load control valves 70,72, upstream of cylinder ports 77,79, is an adjustable restrictor valve 80, which is actuated by a solenoid 82. In “self-steer” mode, solenoid 82 is energised to open the restrictor valve 80, thus providing fluid communication between the ports 77,79 and allowing the piston 36 to move, with a set amount of damping, under the forces imposed on the wheels by the ground, mimicking the behaviour of a self-steer system. In that mode, the solenoids 51,53 are de-energised such that no fluid is output to the cylinder 33 through the load control valves 70,72.

Electrical interlocks (not shown) are provided to prevent solenoid 82 from being energised when the proportional directional control valve 54 is being used (i.e. during active steering or during emergency centring). Because the restrictor valve 80 is closed when solenoid 82 is de-energised, a loss of electrical power will prevent it from operating, whereby a fail-safe characteristic in conferred.

A branch line 96 interconnects a junction 47, disposed on the first supply line 50 upstream of the pressure reducing valve 52, and a junction 88, disposed downstream of accumulator 40, from which runs the second supply line 60. The branch line 96 is provided with a check valve 98 which allows fluid flow in the direction from junction 47 towards junction 49 but not in the reverse direction. An output line 17 from the accumulator 40 adjoins the branch line 96 at a junction 49 which is disposed downstream of the check valve 98 but upstream of the junction 88.

The second supply line 60 is defined between junction 88 and a proportional control valve which functions as an emergency centring valve 64. Provided on the second supply line 60 is a valve 62 comprising a solenoid 63 which when de-energised opens the valve 62 to allow fluid to flow along the second supply line 60 to the emergency centring valve 64.

The emergency centring valve 64 comprises a pair of outlets 65, 67, from which run respective outlet lines 66, 68 for directing hydraulic fluid to the chambers 11, 13 respectively. The outlet lines 66, 68 adjoin the outlet lines 57, 59 at junctions 41,43 respectively which are disposed upstream of inlets 71,73 to the load control valves 70,72. Each outlet line 65,67 is provided with a respective check valve 61,69, to prevent fluid from flowing towards emergency centring valve 64 in outlet lines 66, 68.

The emergency centring valve 64 is operated by a cam arrangement (not shown) which mechanically links one of elongate portions 46,48 therewith and which is movable by that portion to adjust the output from the outlets 65,67 of the emergency centring valve 64 according to the position of the piston rod 34 with respect to a predetermined position thereof, i.e. the direction in which the piston rod 34 is displaced from the predetermined position (and possibly also the amount by which it is so displaced), the predetermined position being that assumed by the piston rod 34 when the or each wheel is straight, whereby an appropriate discharge is output towards a respective one of the load control valves 70,72 to centre the piston 36 and thus effect straightening of the wheels.

The hydraulic circuit further comprises a third supply line 90 which branches off from junction 88, to supply hydraulic pressure to the shot-bolt cylinder 38 to prevent operation of the cylinder 38, and thus locking of the wheels, during active steering or self-steering.

The shot-bolt cylinder 38 houses a piston 37, to one side of which a fluid chamber 42 is defined in the cylinder 38. The cylinder 38 comprises a locking member 35, defined by a rod of the piston 37 (i.e. a “shot-bolt”), the locking member 35 being movable, by movement of the piston 37, from a retracted position to an extended position. In the retracted position (as maintained by fluid pressure supplied to the cylinder 38 by line 90), locking member 35 does not engage the actuating member 20 and thus allows movement of the actuating member 20. Movement of the locking member 35 into the extended position, when the wheels have been straightened, causes it to advance into a space or hole 33 in the second elongate portion 48 to engage that portion and thus obstruct movement of the actuating member 20 to lock the wheels. The cylinder 38 further houses a spring 39 which exerts a force on the other side of piston 37 to bias the locking member 35 towards its extended position. The locking member 35 is arranged to slidably abut the second elongate portion 48, under the biasing force of the spring 39, during the steering of the wheels to their straightforward positions upon the predetermined condition arising, until it becomes aligned with the hole 33, at which point the wheels are straight and at which point the locking member 35 advances, under the biasing force, into the hole 33 to assume its extended position.

Provided on the third supply line 90 is a valve 92 which comprises a solenoid 93 that, when energised, opens the valve 92 to provide fluid communication between the junction 88 and the chamber 42, to enable fluid to be supplied to the chamber 42 along the third supply line 90 and to enable sufficient fluid pressure to be established in the chamber 42 to overcome the biasing force of the spring 39 and thus hold the locking member 35 in its retracted position.

The hydraulic pressure in line 90 is provided from the inlet 45, via junction 47, check valve 98 and junction 88, and also from the accumulator 40, via junctions 49 and 88.

The hydraulic circuit further comprises a fluid return line 100 which branches off from the third supply line 90 at a junction 87 provided between solenoid valve 92 and cylinder 38. The return line 100 returns the hydraulic fluid to a tank 31.

The fluid return line 100 is provided with a fluid discharge valve 94 which comprises a solenoid 95 that is arranged to be energised to keep the valve 94 closed whilst the solenoid valve 92 is open, such that hydraulic pressure may build and be maintained in third supply line 90 to ensure the locking member 35 is retracted.

The return line 100 connects, at a junction 101 disposed downstream of the fluid discharge valve 94, with a return line 102 from the load control valves 70,72. The return line 100 also connects, at a junction 103, disposed downstream of the fluid discharge valve 94, with return lines 104 and 106 from proportional directional control valve 54 and emergency centring valves 64 respectively.

The operation of the unit will now be described with reference to the drawings and foregoing description.

Hydraulic fluid from the power pack enters the manifold block 44 and fills the accumulator 40 via inlet 45 and check valve 98.

In either active steering or self-steering modes, each of the solenoids 63, 92 and 94 is energised, such that valve 62 is closed to isolate emergency centring valve 64, and valves 92 and 94 are respectively open and closed whereby the locking member is retracted to be clear of second elongate portion 48.

In active steering mode, steering is controlled by the proportional directional control valve 54, in conjunction with pressure reducing valve 52, one of solenoids 51,53 being energised at any given time to effect appropriate the supply of fluid to the cylinder, via the corresponding load control valve 72/74, for steering.

In self-steering mode, solenoid 82 is energised to keep the restrictor valve 80 open, thus allowing fluid to pass therethrough, under forces transmitted from the wheels to the piston 36, from one of chambers 11 and 13 to the other, thus damping movement of the wheels.

In locking mode, i.e. upon the predetermined condition arising, all solenoids are de-energised. De-energising solenoids 63 and 93 causes valve 62 to open and valve 92 to close, respectively, such that fluid is directed to the emergency centring valve 64 along second line 60, under pressure from the accumulator 40 and/or pressure from the inlet 45 via junction 47 and check valve 98. De-energising solenoid 95 opens valve 94 to allow release of fluid from the shot-bolt cylinder 38 into line 100, so that the biasing force of the spring 36 advances the locking member 35, thus forcing it against the second elongate portion 48 if the wheels are not straight (i.e. if the piston 36 is not in the central position in the cylinder 32 as shown in FIG. 2B). In this position, the end of the locking member 35 is urged against the second elongate portion 48 under the spring bias, slidably abutting that portion in readiness to be moved into the hole 33 when brought into alignment therewith.

The emergency centring valve 64, under the operation of the cam arrangement referred to above, provides the appropriate output of fluid, either to load control valve 71 or load control valve 72 according to the position of the piston 36 relative to the straight-forward position, to effect rapid centring of the piston 36 and corresponding straightening of the wheels, whereupon the locking member 35 is received in the hole 33 to lock the wheels.

Advantageously, the unit is able to effect emergency steering and locking in the event of an electrical power failure (being one example of a predetermined condition) causing the solenoids 51,53,82,63,93,95 to be de-energised. In particular, de-energising solenoid 82 closes valve 80 so that it will not upset the output from either of the load control valves 76 and 78 to the appropriate cylinder port 77/79, and de-energising of solenoids 51 and 53 will close proportional directional control valve 54 to isolate lines 66 and 68 from line 50, so that the entirety of the output from the emergency centring valve 64 will effect steering.

Moreover, in the event of a hydraulic failure (being another example of a predetermined condition), such as due to a power pack failure or severing of the external hydraulic supply to the manifold block 44, owing to the provision of the accumulator 40 and the check valve 98, the centring may be effected purely by the accumulator pressure so that the steering and locking can be effected.

In these respects, the unit 10 is fail-safe.

It will be appreciated that other embodiments of the invention may be applied to other steerable trailing wheels, such as the trailing wheels of a corresponding semi-trailer tractor unit or indeed the trailing wheels of another vehicle.

In alternative embodiments, the sub-assembly 8 depicted in FIG. 1B may be adapted such that the unit 10 thereof is connected to steerable wheels provided on further axle beams, via an appropriate linkage arrangement, to effect steering and locking of those wheels also. In one such embodiment, the body and the locking means may be arranged to be supported from different ones of the axles, with the linkage possibly being supported from a different axle still, thus exploiting the plural axle beams to distribute the components of the system.

In another embodiment, the sub-assembly 8 may be modified such that two units according to the invention, instead perhaps comprising single-rod rather than dual-rod pistons, are mounted to the axle beam 12, one controlling each wheel, whereby the left and right wheels on each axle would be able to be steered independently so as to achieve perfect Ackermann steering geometry at all times.

Furthermore, in an alternative embodiment, the hole 33 may be provided in another part of the steering linkage 9, such as a tie rod 18 or steering arm 22, with the locking member 35 being arranged to slidably abut that other part until it becomes aligned with the hole 33, at which point the wheels are straight and at which point the locking member 35 advances, under the biasing force, into the hole 33 to assume its extended position.

In a further alternative embodiment, the unit 10 may comprise a rotary actuator (which may comprise an output shaft which constitutes the actuating member) mounted on one of the kingpins 16, to centre the wheel adjacent that kingpin. The actuating member in such an embodiment may be positionable such that an axis of rotation of the actuating member is parallel or collinear with a steering axis the wheel adjacent that kingpin. The opposite wheel may be moved and centred either by a linkage extending from that actuator or by a further, identical, actuator mounted to the kingpin adjacent the opposite wheel (whereby Ackermann geometry may be achieved). The rotary actuator(s) may be hydraulic, pneumatic or electric and may define, i.e. provide or form a part of, the body.

In another embodiment, the body may be supportable from a body of the vehicle, so as to be located a considerable distance from the road and thus less vulnerable to road debris and enjoy the vibration-absorbing characteristics of the vehicle suspension, whereby the life of the system may be prolonged.

It should be noted that the linkage may form a part of the system according to the invention.

1. A safety system for at least one wheel of a vehicle, the system comprising an actuating means and a locking means and being arranged such that, upon a predetermined condition arising, the actuating means effects centering of the at least one wheel and the locking means then effects locking of the at least one centered wheel.

2. A system according to claim 1, the system having a body which is arranged to be supported from the vehicle, wherein the actuating means comprises an actuating member which is received by the body and displaceable with respect to the body to effect movement of a linkage to center the at least one wheel.

3. A system according to claim 2, wherein the actuating member is adapted to form part of the linkage.

4. A system according to claim 2, wherein the actuating member is adapted to engage the linkage.

5. A system according to claim 2, being for at least one wheel pivotally supported from an end of an axle beam of the vehicle by a pivotable member, the pivotable member forming part of the linkage.

6. A system according to claim 5, wherein the actuating member is displaceable linearly with respect to the body.

7. A system according to claim 5, wherein the actuating member is displaceable rotationally with respect to the body.

8. A system according to claim 7, the system being arranged such that the actuating member has an axis of rotation which is parallel or collinear with the pivot axis of a pivotable member.

9. A system according to claim 5, wherein the body is arranged to be supported from the axle beam.

10. A system according to claim 9, wherein the body is arranged to be fixed with respect to the axle beam.

11. A system according to claim 5, wherein the body is arranged to be supported from a body of the vehicle.

12. A system according to claim 6, wherein the actuating member is pivotally connectable to one end of a respective tie rod, adapted to form part of the linkage, the other end of which pivotally connects with the pivotable member.

13. A system according to claim 2, wherein the locking means comprises a locking member, the locking member being movable between a first position, in which it allows movement of the linkage, and a second position, in which it prevents movement of the linkage when the at least one wheel is centered.

14. A system according to claim 13, wherein the locking member is arranged to be urged towards its second position upon the predetermined condition arising but to be prevented from reaching its second position unless the at least one wheel is centered.

15. A system according to claim 14, wherein the locking member is moveable in a direction transverse to that in which the linkage is displaceable and is arranged, when urged towards its second position, to abut the linkage slidably whilst the at least one wheel is not centered and to move, into a space in the linkage, to its second position to engage the linkage upon the at least one wheel being centered.

16. A system according to claim 15, wherein the actuating member is arranged to be slidably abutted by the locking member when urged towards its second position whilst the at least one wheel is not centered, and wherein the space is provided in the actuating member.

17. A system according to claim 6, wherein the actuating member comprises a first elongate portion, received in the body, and a second elongate portion which is aligned with but offset from the first elongate portion and is fixed with respect to the first elongate portion, the second elongate portion being slidably received by the body to prevent rotation of the body with respect to the first elongate portion.

18. A system according to claim 17, wherein the second elongate portion is arranged to be slidably abutted by the locking member when urged towards its second position whilst the at least one wheel is not centered, and wherein the space is provided in the second elongate portion.

19. A system according to claim 5, wherein the system is arranged to effect centering and locking of a wheel which is supported from a single end of the axle beam.

20. A system according to claim 19, the system comprising a double-acting cylinder and a piston received in the cylinder, wherein the actuating member comprises a rod extending from one side of the piston.

21. A system according to claim 5, wherein the system is arranged to effect centering and locking of a pair of wheels supported from opposite ends of the axle beam.

22. A system according to claim 21, wherein the system comprises a double-acting cylinder and a piston received in the cylinder, wherein the actuating member comprises a rod extending from one side of the piston and a further rod extending from the other side of the piston, the rod being to impart torque to the pivotable member of one wheel of the pair of wheels and the further rod being to impart torque to the pivotable member of the other wheel of the pair of wheels.

23. A system according to claim 21, wherein the system is arranged to effect centering of the pair of wheels via a fixed geometry linkage.

24. A system according to claim 19, wherein the system is arranged to effect centering and locking of at least one further wheel pivotally supported from an end of at least one further axle beam of the vehicle by a pivotable member, via a further linkage, the further linkage interposed between the system and the at least one or each further wheel.

25. A system according to claim 24, wherein the body and the locking means are arranged to be supported from different ones of the axles.

26. A system according to claim 24, wherein the system is arranged to effect centering of the at least one wheel upon the predetermined condition arising, under the release of energy stored therein.

27. A system according to claim 26, further comprising an accumulator, arranged to supply fluid to the cylinder to effect centering of the at least one wheel, upon the predetermined condition arising.

28. A system according to claim 27, the system comprising a valve interposed between the accumulator and the cylinder, the valve arranged to be closed by a supply of electrical power thereto and to be open, to allow supply of fluid from the accumulator to the cylinder, when not supplied with electrical power.

29. A system according to claim 2, the system comprising a double-acting cylinder and a piston received in the cylinder to define therein a first chamber to one side of the piston and a second chamber to the other side of the piston, wherein the actuating member comprises a rod of the piston, the system further comprising a fluid inlet, to receive fluid from a fluid source, a first line, in fluid communication with the inlet and arranged to supply fluid to the first or second chamber to effect centering of the at least one wheel when the predetermined condition has not arisen, and a second line, arranged to supply fluid to the first or second chamber to effect centering of the at least one wheel upon the predetermined condition arising.

30. A system according to claim 29, further comprising an accumulator, arranged to supply fluid to the second line, wherein the second line comprises a valve which is openable to allow fluid to flow from the accumulator through the second line upon the predetermined condition arising.

31. A system according to claim 30, wherein the valve in the second line comprises a solenoid arranged to be de-energized upon the predetermined condition arising to open the valve.

32. A system according to claim 29, further comprising a variable control valve, interposed between the second line and the cylinder, the variable control valve comprising a first outlet, arranged to supply fluid to the first chamber, and a second outlet, arranged to supply fluid to the second chamber, the variable control valve being arranged to output fluid, according to the position of the at least one wheel, through one of the first and second outlets, to effect centring of the at least one wheel when the predetermined condition has arisen.

33. A system according to claim 32, being configured such that the at least one wheel is centered at a predetermined position of the piston rod with respect to the cylinder, wherein the variable control valve is arranged to output fluid according to the position of the piston rod with respect to the predetermined position.

34. A system according to claim 33, further comprising a cam arrangement, mechanically linking the piston rod and the variable control valve, which is movable by the piston rod to adjust the output from the proportional control valve according to how far the piston rod is displaced from the predetermined position.

35. A system according to claim 32, comprising a further variable control valve, interposed between the first line and the cylinder, the further variable control valve comprising a first outlet, arranged to supply fluid to the first chamber, and a second outlet, arranged to supply fluid to the second chamber, the variable control valve being arranged to output fluid, through its first and second outlets, to effect centering of the at least one wheel according to signals corresponding to the position of a steering wheel of the vehicle when the predetermined condition has not arisen.

36. A system according to claim 35, wherein the further variable control valve comprises a first solenoid, arranged to control the output from the first outlet of the further variable control valve, and a second solenoid, arranged to control the output from the second outlet of the further variable control valve, the first and second solenoids being arranged to be de-energized upon the predetermined condition arising to close the first and second outlets of the further variable control valve.

37. A system according to claim 35, comprising first and second outlet lines connected to the first and second outlets, respectively, of the variable control valve, and first and second further outlet lines, connected to the first and second outlets, respectively, of the further variable control valve, wherein the first outlet line and first further outlet line meet at a first junction and the second outlet line and second further outlet line meet at a second junction, and wherein the first and second outlet lines are respectively provided, upstream of the junctions, with first and second oneway valves preventing fluid flow in the direction from the junctions towards the variable control valve.

38. A system according to claim 37, further comprising a first load control valve, interposed between the first junction and the first chamber, and a second load control valve, interposed between the second junction and the second chamber.

39. A system according to claims 29, wherein the locking means is arranged to effect locking under the release of energy stored in the system.

40. A system according to claim 39, wherein the locking means is arranged to effect locking under the action of a resilient bias.

41. A system according to claim 39, wherein the locking means is arranged to receive fluid, to prevent it from effecting locking, under the release of the stored energy, the system comprising a third line arranged to supply fluid to the locking means, the third line having a valve which is arranged to be open, to allow fluid supply to the locking means when the predetermined condition has not arisen, and closed upon the predetermined condition arising, the system further comprising a fluid discharge valve arranged to be closed, to prevent fluid from being discharged from the locking means when the predetermined condition has not arisen, and open, to allow fluid to be discharged from the locking means upon the predetermined condition arising.

42. A system according to claim 41, wherein the locking means comprises a further cylinder and a further piston received therein to define, to one side of the further piston, a further chamber, the locking means further comprising a locking member extending from the further piston to be moveable between a first position, in which it allows movement of the actuating member, and a second position, in which it prevents movement of the actuating member when the at least one wheel is centered, the locking member being moveably into the second position under the release of the stored energy.

43. A system according to claim 41, wherein the valve of the third line comprises a solenoid which is arranged to be de-energized upon the predetermined condition arising to close the valve of the third line.

44. A system according to claim 41, wherein the fluid discharge valve comprises a solenoid which is arranged to be de-energized upon the predetermined condition arising to open the fluid discharge valve.

45. A system according to claim 41, wherein the third line is arranged to be supplied, at a position therealong which is upstream of the valve on the third line, with fluid from the accumulator.

46. A system according to claim 45, wherein the valve on the third line is arranged to open to allow fluid to be supplied to the locking means, to unlock the at least one wheel, only if fluid pressure upstream of the valve in the third line reaches a predetermined level.

47. A system according to claim 45, wherein the bias in the locking means is set high enough such that it will prevent unlocking of the at least one wheel until the fluid pressure in the accumulator reaches a predetermined level, the predetermined level being sufficient to overcome the bias.

48. A system according to claim 29, wherein the second line is arranged to be supplied, at a position therealong which is upstream of the valve on the second line, with fluid from the inlet, the system further comprising a one-way valve, interposed between the inlet and said position, to prevent fluid from flowing from the second line towards the inlet.

49. A system according to claim 41, wherein the third line is arranged to be supplied, at a position therealong which is upstream of the valve on the third line, with fluid from the inlet, the system comprising a one-way valve, interposed between the inlet and said position, to prevent fluid from flowing from the third line towards the inlet.

50. A system according to claim 48, wherein the accumulator is arranged to be filled with fluid from the inlet via the one-way valve.

51. A system according to claim 1, wherein the predetermined condition is constituted by a fault, the fault comprising loss of power to the system, a loss of fluid pressure in the system, a sensor failure, an electrical failure and/or a controller error, or the predetermined condition is constituted by a controller-detected emergency situation.

52. A system according to claim 51, wherein the controller-detected emergency situation comprises a burst tire, failure of another component, or an imminent rollover.

53. A system according to claim 1, being adapted output an alert signal for notification to a driver of the vehicle that the predetermined condition has arisen.
